(19) United States
(12) Patent Application Publication
(10) Pub. No.: US 2008/0065878 A1
(43) Pub. Date: Mar. 13, 2008

(54) Method and system for encrypted message transmission

(76) Inventors: Michael Hutson, Ontario (CA); Derek Ritz, Ancaster (CA); Charles Bouvette, Hamilton (CA); Jeff Cummings, Burlington (CA); Rick Ensing, Rockwood (CA); Simon Blake-Wilson, Amsterdam (NL); Russ Baird, Mississauga (CA)

Correspondence Address: BERESKIN AND PARR, 40 KING STREET WEST, BOX 401, TORONTO, ON, M5H 3Y2, US

(21) Appl. No.: 11/517,503

(22) Filed: Sep. 8, 2006

(51) Int. Cl. H04L 9/00

(52) U.S. Cl. 713/153

(57) ABSTRACT

A method for the secure transmission of an electronic message from a sender to a recipient. The method comprises receiving an encrypted sender transmission file transmitted from a sender computer station at a management server, wherein the sender transmission file comprises one or more signed hash values, a sender identifier and one or more recipient identifiers. The signature values are created from one or more message components associated with the electronic message composed at the sender computer station. The encrypted sender transmission file is decrypted; and a comparision is made with of the one or more signed hash values. For each of the one or more recipient identifiers, one or more recipient public keys; is retrieved.

### FIELD OF THE INVENTION

The present invention relates to a method and system for encrypting and securely transmitting electronic messages, and more specifically to a method and system for centrally storing, managing and distributing keys and providing notary services of the transmissions.

### BACKGROUND OF THE INVENTION

Electronic messages often contain sensitive information, and therefore, it is imperative that electronic messages be protected from possible interception and/or alteration during the course of transmission. One technique that is widely used to prevent the interception and/or alternation of messages is encryption.

There are various encryption techniques that may be used. One encryption technique is symmetric key encryption, which is also referred to as private-key encryption. In symmetric key encryption, the information is first encrypted using a secret key. The secret key is then shared only between users who require the key in order to decrypt the information. As the users who will decrypt the encrypted message require the secret key, it is imperative that only users who require access to the secret key be given access. Therefore, secure communication channels must be used to share the secret key.

One of the problems with symmetric key encryption techniques is that the key must be kept secret. Therefore, it is possible that an unauthorized user may come into possession of the secret key, and use that secret key to decrypt the encrypted transmission. One technique that is used to address the deficiencies associated with symmetric key encryption is public key encryption. Public key encryption makes use of a private and public key pair. The owner of the private and public key pair, keeps the private key secret, and shares the public key. A message is encrypted with the public key, and then sent to the owner of the public private key pair. The message, when received by the owner is decrypted using the private key. Therefore, with public key encryption, the private key does not need to be shared with anyone, while the public key may be shared with any party.

The keys that are used in public key encryption are relatively large compared to those used in symmetric key encryption. The keys used in public key encryption are relatively large due to the mathematics upon which public key cryptography is based. As a result, public key encryption and decryption are considerably more processor intensive than symmetric key encryption algorithms.

A common problem with both symmetric and public key encryption is the distribution methods associated with each key system. The onus of providing the recipient of an encrypted message with the appropriate key is cumbersome and non-intuitive for the average person. The problem is compounded in a public key system when a key set expires and/or is revoked. Aside from the inefficiencies associated with the various encryption techniques, use of such techniques are often required to track and protect the use of their encryption keys to ensure that only authorized users have access to them.

### SUMMARY OF THE INVENTION

In accordance with a first aspect of the invention, there is provided a method for the secure transmission of an electronic message from a sender to a recipient. The method comprises receiving an encrypted sender transmission file transmitted from a sender computer station at a management server, wherein the sender transmission file comprises one or more signed hash values, a sender identifier and one or more recipient identifiers; wherein the one or more signature values are created from one or more message components associated with the electronic message composed at the sender computer station; decrypting the encrypted sender transmission file; comparing the one or more signed hash values accessible to the management server with one or more second hash values accessible to the recipient computer station; retrieving for each of one or more recipient identifiers, one or more recipient public keys; transmitting to the sender computer station a second transmission file, wherein the second transmission file contains the one or more recipient public keys, the sender identifiers, and the one or more recipient identifiers; wherein at the sender computer station a first container file is created, and is transmitted to the recipient computer station.

In accordance with a second aspect of the invention there is provided a key management server system for processing encrypted electronic messages originating from a sender computer station destined for a recipient computer station. The system comprises a memory means comprising a transmission database and subscriber database, wherein the transmission datastore records transmission events, and the subscriber datastore records subscriber information; a processor means connected to the memory means, the processor operable to allow the key management server to: i) receive an encrypted sender transmission file transmitted from the sender computer station wherein the sender transmission file comprises one or more first signed hash values, a sender identifier and one or more recipient identifiers; wherein the one or more hash values are created from one or more message components associated with an electronic message composed at the sender computer station; ii) decrypt the encrypted sender transmission file; iii) retrieve for each of one or more recipient identifiers, one or more recipient public keys stored in the subscriber datastore; and iv) transmit to the sender computer station a second transmission file, wherein the second transmission file contains the one or more recipient public keys, the sender identifier, and the one or more recipient identifiers; wherein at the sender computer station a first container file is created, and is transmitted to the recipient computer station.

### BRIEF DESCRIPTION OF THE DRAWINGS

For a better understanding of embodiments of the systems and methods described herein, and to show more clearly how they may be carried into effect, reference will be made by way of example, to the accompanying drawings in which:

FIG. 1 is a block diagram illustrating the components of a secure message transmission system;

FIG. 2 is a block diagram illustrating the interaction between a sender, a server service and a recipient;

FIG. 3 is a block diagram illustrating the interaction between a transmission file and a management server;

FIG. 4 is a flow chart illustrating the steps of a subscription method;

FIG. 5 is a flow chart illustrating the steps of an activation method;

FIG. 6 is a block diagram of a sample email window;

FIG. 7 is a flow chart illustrating the steps of an initiate transmission method;

FIG. 8 is a block diagram illustrating the components of a sender transmission method;

FIG. 9 is a block diagram illustrating the components of a transmission file to sender;

FIG. 10 is a flow chart illustrating the steps of a transmission method;

FIG. 11 is a block diagram illustrating the components of the container files used to transmit messages; and

FIG. 12 is a flow chart of a recipient processing method; and

FIG. 13 is a flow chart illustrating the steps of a verification process.

### DETAILED DESCRIPTION OF THE INVENTION

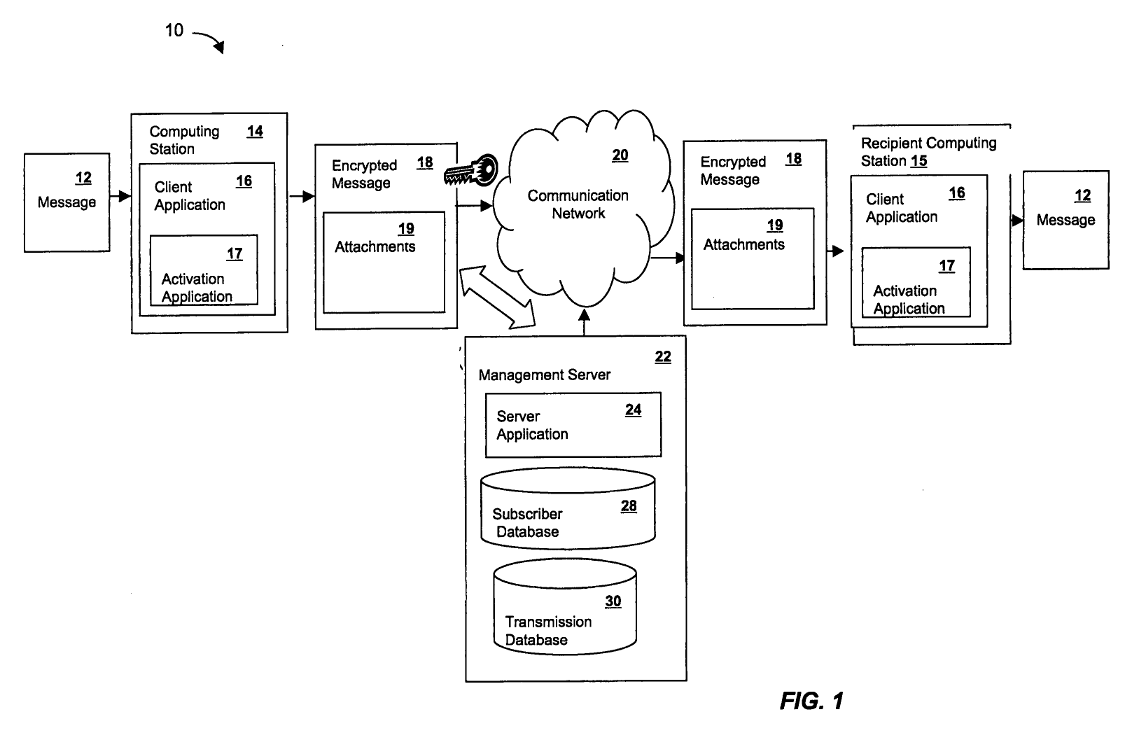

Reference is now made to FIG. 1, where the components of a secure message transmission system 10 are shown in an exemplary embodiment. The secure transmission system 10 is used to transmit an electronic message 12 between computing stations 14. The electronic message 12 is any data that may be transmitted electronically between computing stations and includes, but is not limited to an electronic mail message, text file any other data type file. In an exemplary embodiment, the electronic message 12 is an electronic mail message. The electronic message 12 may be created upon a computing station using any application that is used to author and create electronic mail messages. Such applications may include, but are not limited to, Microsoft Outlook™, and email services that are available as web based email (i.e. Microsoft Hotmail™, Yahoo Mail™, Gmail™, etc. The electronic message 12 is composed upon a computing station 14. The computing station 14 is a computing device that connects to a communication network 20, and that allows a user to compose, transmit and recieves an electronic message 12. The electronic message 12 may include components of an electronic mail message, including a recipient address, and any one of or combination of, a subject, a subject, a body, or one or more attachments. The computing station 14 includes, but is not limited to a stand alone computing device, a laptop computer, a dedicated kiosk, a handheld computer, a wireless email device (e.g., a blackberry™), or a slim line computer. In an exemplary embodiment, the computing station 14 has installed upon it, or accessible to it, a client application 16, and an activation application 17. The client application 16 allows for an electronic message to be transmitted from a computing station 14, and to be received at a computing station 15. The client application 16, as is explained in detail below, retrieves the appropriate recipient public keys from the server application 24, and submits transmission events to the server application 24. The client application 16 also encrypts the electronic message that is to be transmitted from the computing station 14, and decrypts electronic message 12 that are received at the computing station 15. The activation application 17, as is explained in further detail below is used to generate the required encryption keys for a user of the system 10. Users of the secure transmission system 10 are referred to as subscribers The electronic message 12 that the user transmits from the computing station 14 is encrypted, and an encrypted message 18 is generated. The contents of the encrypted message, and its method of encryption are explained in further detail below. The encrypted message 18, may comprise one or more attachments 19. The attachments 19 may be any file type that is accessible to the computing station 14. The encrypted message 18 is transmitted to a receiving computing station 15 through a communication network 20. The communication network 20 is any network that allows for the transmission of data, and includes, but is not limited to the Internet, an Intranet, wide area networks (WAN), or local area networks (LANS). The message that is transmitted from the computing station 14 is received by the receiving computing station 15 as is consistent with the associated transmission protocol. Both the transmitting and receiving computing stations 14 and 15 communicate with the management server 22. The management server 22 is a server type computing device that acts as a centralized subscriber public key management and repository and transmission event notary service for computing stations 14 and 15. The management server 22, has resident upon it, or accessible to it a server application 24. The server application 24 allows for the submission and distribution of public keys and transmission event notary services in encrypted form from computing stations 14 and 15, and is explained in further detail below. The management server 22 has accessible to it, or resident upon it, one or more databases that are used when messages are transmitted between computing stations 14 and 15. In an exemplary embodiment, the Management server 22 has accessible to it, or resident upon it, a subscriber database 28, and a transmission database 30. The subscriber database 28, as is described in further detail below, and is used to record information regarding the subscribers of the system 10. The transmission database 30, as is, explained in further detail below, is used to record information regarding the messages that are transmitted through the system 10.

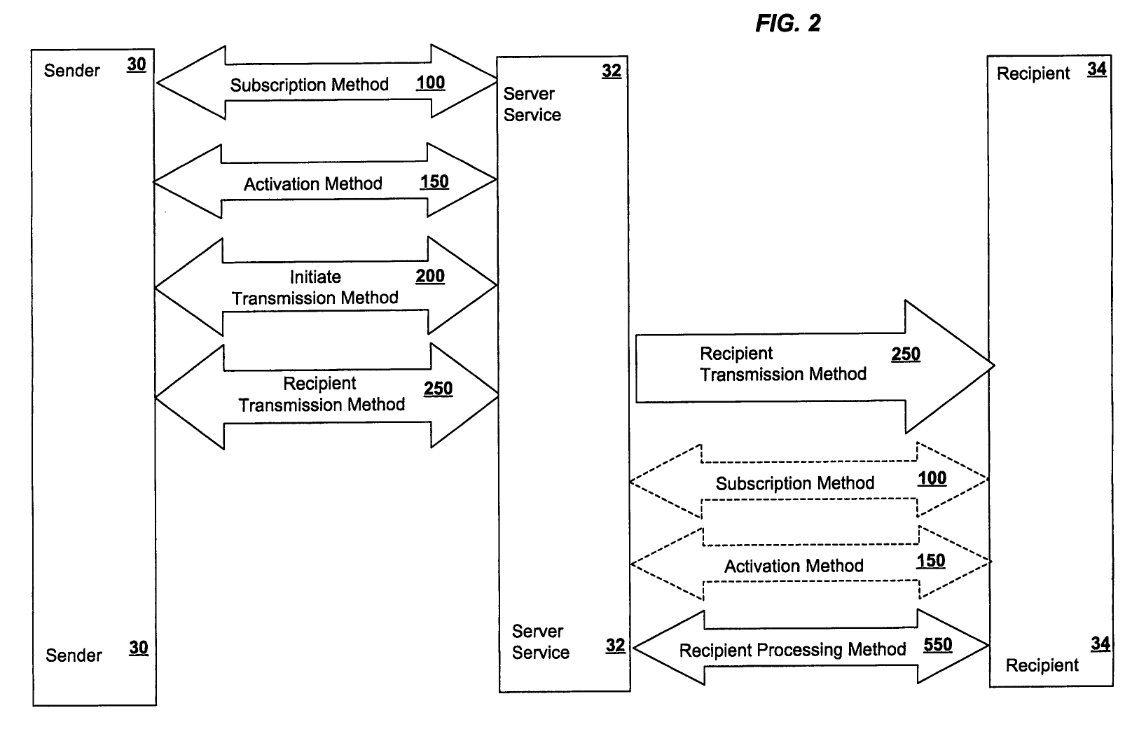

Reference is now made to FIG. 2, where a block diagram illustrating the interaction between a sender 30, a server application 24 resident upon a management server, and the recipient 34 is shown. The sender 30 is a registered subscriber of the system 10. The sender 30 may transmit encrypted messages 18 to both registered and unregistered recipients 34. A user may register with the server application 24. using the subscription method 100. The server application 24, in an exemplary embodiment, is administered by the management server 22. A user signs up with the server application 24 through a subscription method 100 as explained in detail below. Upon the completion of the subscription method 100, the server service 32 allows for the user to engage an activation method 150 as explained in detail below. The activation method 150 allows the user to have installed upon their respective computing station, the client application 16 and the activation application 17 and for the appropriate set up to be conducted upon the computing station 14 and 15. Upon the sender 30 having installed the appropriate applications, the sender is able to transmit encrypted messages 18 starting with an initiate transmission method 200. The initiate transmission method 200 as explained in detail below, allows a sender to initiate the process by which an electronic message 12 will be transmitted. The recipient transmission method 250 allows the computing station 14 to encrypt and transmit the electronic message 12 directly to the recipient 34, and more specifically to the recipient's computing station 15. Upon receipt of an encrypted message 18 at the recipient's computing station 15, the encrypted message 18 is decrypted and an acknowledgement message is sent back to the server application 24 via a recipient processing method 550.

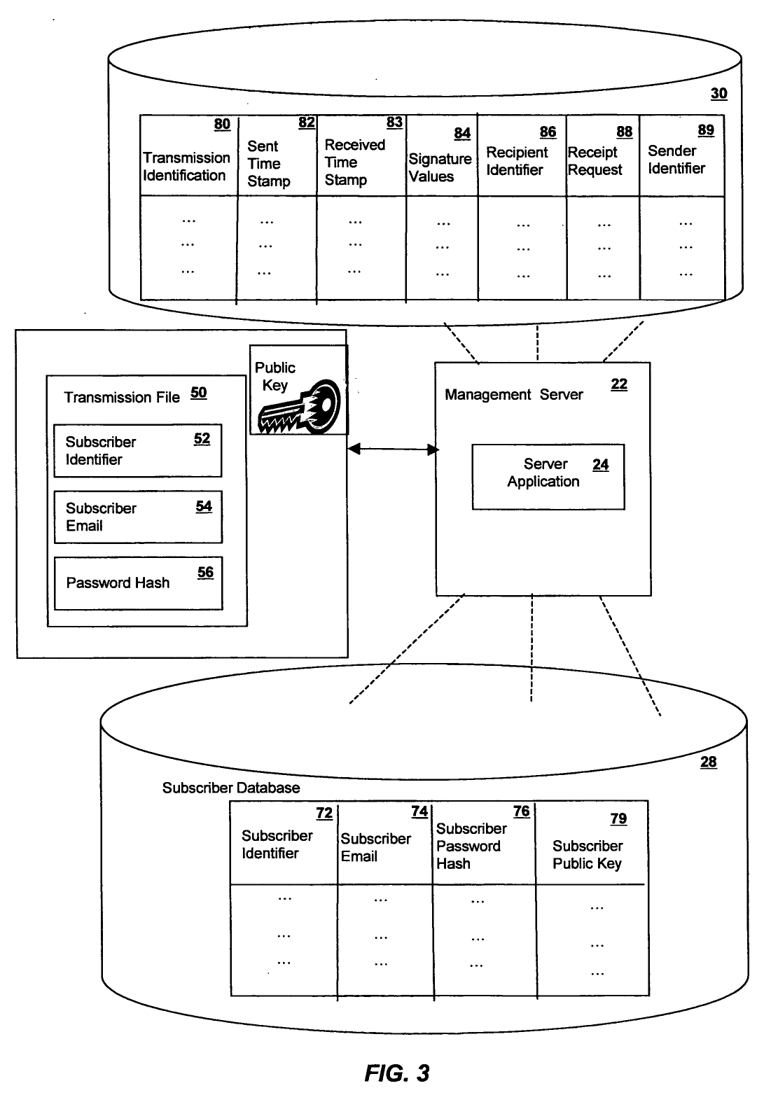

Reference is now made to FIGS. 3-5, where the steps of an activation and subscription method are illustrated with reference to FIG. 3. Reference is now made to FIG. 3, where a block diagram illustrating the interaction between the sender's computing station 14 and the management server 22. In an exemplary embodiment, a user who is attempting to subscribe to the system as described in the subscription method 100 will have their respective computing station 14 transmit to the management server 22 a transmission file 50, a subscriber identifier 52, a subscriber email address 54, and a cryptographic hash of the subscriber password 56. The subscriber identifier 52 is a unique identifier that is associated with each unique subscriber. The subscriber email address 54 is the email address associated with the subscriber. The cryptographic hash of the subscriber password is the message digest obtained by applying a standard cryptographic hashing algorithm on the password that the subscriber provided when they first signed up to use the system 10. In an exemplary embodiment, the transmission file 50 is an XML file. In alternative embodiments, a text file, a CSV file or any other file type may be used for transmission. In alternative embodiments, other information may be provided in the transmission file including but not limited to the subscribers first and last name, address and phone number.

The subscriber database 28 in an exemplary embodiment is used to record information regarding the subscribers who use the system 10. In an exemplary embodiment, the subscriber database is comprised of a subscriber identifier field 72, a subscriber email field 74, a subscriber password hash field 76, a subscriber public key field 78 The subscriber identifier field 72 is used to store the subscriber identifier 52. The subscriber email field 74 is used to store the subscriber email address 54. The subscriber password hash field 76 is used to store the subscriber password hash 56. Each subscriber has associated with it, a public key private key pair that is generated upon the user invoking the activation application 17 to use the system 10. In an exemplary embodiment, the asymmetric keys of the public/private key pair will have a length of 1024 bits. The subscriber public key field 78 stores the public key associated with the subscriber

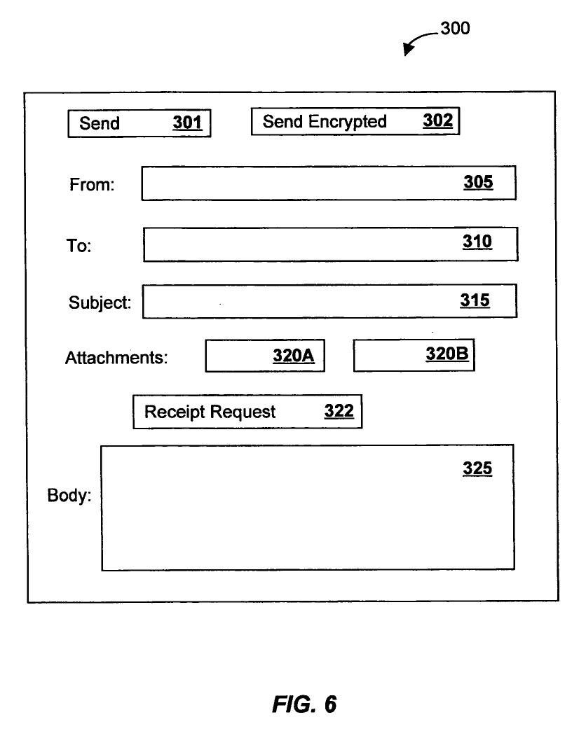

The transmission database 30 in an exemplary embodiment is used to record information regarding transmissions of encrypted messages 18 from a sender 30 to a recipient 34. The transmission database 30 in an exemplary embodiment comprises a transmission ID field 80, a sent timestamp field 82, a receive timestamp field 83, a signature values field 84, and a recipient field 86, a receipt request field 88 and a sender identifier field 89. Each encrypted message has a unique transmission identifier associated with it. For each encrypted message 18, the transmission identifier is stored in the transmission ID field 80. The sent timestamp field is used to record a timestamp that is associated with when the electronic message 12 is encrypted by the sender 30. The received timestamp is used to record a timestamp that is associated with when the encrypted message 18 is opened by the recipient 34. The signature values field 84, as described in detail below is used to store the signature values that are taken of the various components associated with an electronic message 12. The components of an electronic message for which a signature may be created are described in further detail with reference to FIG. 6 in an exemplary embodiment. Other message types that are transmitted electronically may have other components associated with them, depending on their specific format. The recipient identifier field 86 is used to record the recipient that the message 18 is intended for. A separate record is created for each recipient. The receipt request field 88 is used to indicate that the sender wishes to be sent a notification when the recipient opens the message 18. The sender identifier 89 is used to record the sender of the electronic message 12. The method by which the transmission database 30 is populated is described in further detail below.

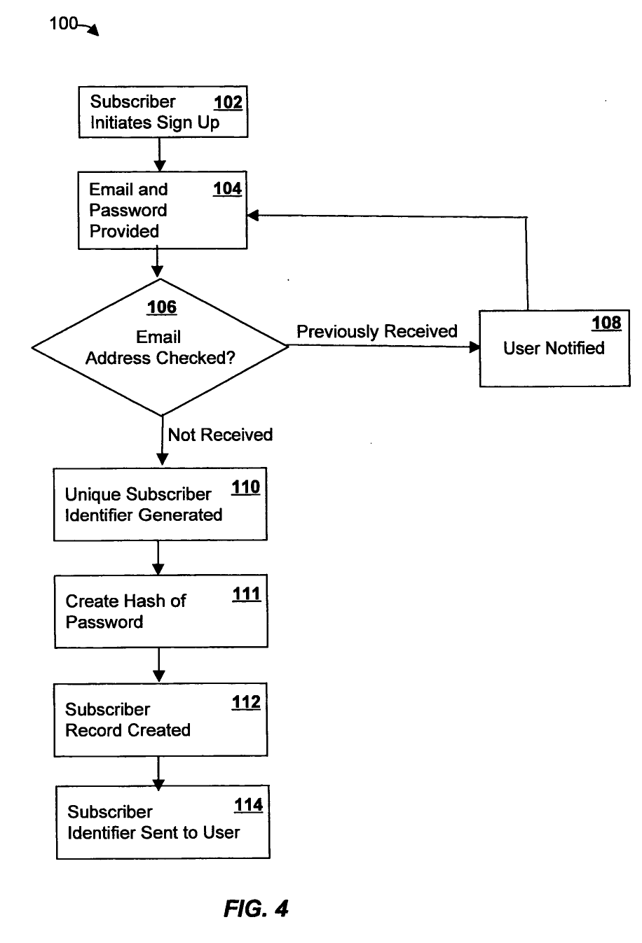

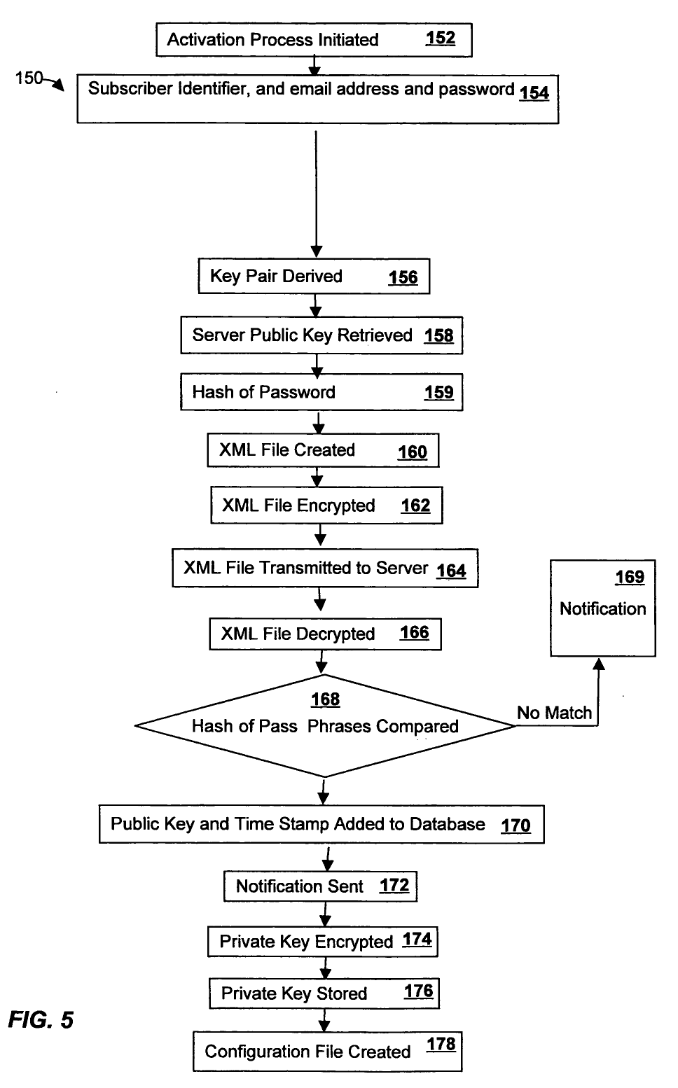

Reference is now made to FIG. 4, where the steps of a subscription method 100 are shown in an exemplary embodiment. The subscription method 100 allows a user who wishes to use the system 10 to transmit and receive messages, to sign up for such use. In an exemplary embodiment, the server application 24, has associated with it a website, that users who wish to sign up for use of the system 10 can use. This website may be hosted by any computing device. The Website will present the user with a form allowing for the entry of required by the subscription method 100. The website will securely communicate with the server service 32 and more specifically method 100 via a secure link such as Secure Sockets Layer, SSL. Method 100 begins at step 102. At step 102, the user initiates the sign up to use the system 10. Method 100, then proceeds to step 104, where the user, in order to sign up to use the system, provides a subscriber email address 54 and a subscriber password 56. The user, will also provide other information as well, including information regarding the computing platform the user is using, The information that is entered by the user is provided to the server application 24. Method 100 then proceeds to step 106, where the server application 24 performs a check to determine whether the email address that the user has provided, has previously been used to sign up for the system 10. If at step 106, it is determined that the email address has been provided previously, method 100 proceeds to step 108. At step 108, a notification message is provided to the user indicating that the email address has already been used, and that another email should be provided. If at step 106, it is determined that the email address has not been used in registering with the system 10, method 100 then proceeds to step 110, where a unique identifier 52 that is to be associated with the email address is created. The subscriber identifier 52 is used to identify a user as a subscriber to the system 10, and therefore a user that is able to receive and transmit encrypted messages 18. Method 100 then proceeds to step 111 where a cryptographic hash of the password is created. Method 100 then proceeds to step 112 where a subscriber record is created in the subscriber database 28. The unique identifier 52, email address and password hash are inserted into the subscriber record. Method 100 then proceeds to step 114, where the subscriber identifier 54 is sent to the user at the subscriber email address 54 that was specified by the user. Upon a subscriber identification being generated, the user in an exemplary embodiment is permitted to download the software applications that may be required in order to use the system 10. At the conclusion of method 100, the user has successfully subscribed to make use of the system 10. The method by which the users computing platform prepares for use of the system 10 is described with reference to activation method 150, as described in FIG. 5.

Reference is made to FIG. 5, where the steps of an activation method 150 are shown in an exemplary embodiment. The activation method 150 generates the public key private key pair that are associated with each subscriber. The keys that are generated are used when messages are transmitted and received. The public key is provided to the subscriber database and the private key is stored locally as explained below. Method 150 begins at step 152, where the activation process is initiated. The process may be initiated in an exemplary embodiment, when a software application is installed upon the respective computing station of the user. The activation process associated with the software that is being installed, which is referred to as the activation application 17 Step 154, requires the user to enter the subscriber email address 54, subscriber password, that they had previously entered in step 104, and the subscriber identifier 52 sent to the user in step114. Method 100 proceeds to step 156 which creates the public key and private key that is to be associated with the subscriber. Method 150 then proceeds to step 158, where the activation application 17 retrieves through a secure communication channel such as SSL, by means of the communication network, a public key associated with the server application 24. The server application 24 has associated with it a public/private key pair (not shown) issued by a well known certificate authority. In an exemplary embodiment, the server public key is retrieved from the server application 24 through a secure communication channel, such as secure socket layer (SSL). Method 150 then proceeds to step 159, where a hash value of the subscriber password is created. Method 150 then proceeds to step 160, where a transmission file 50 is created. As discussed above, in an exemplary embodiment, the transmission file 50 is an XML file. Also at step 160, after the transmission file 50 has been created, the subscriber identifier 52, the subscriber email 54, and the subscriber password hash 56 and the subscriber public key generated in step 156 are inserted into the transmission file 50. Method 150 then proceeds to step 162, where the transmission file 50 that contains the subscriber identifier 52, the subscriber email 54, the subscriber password hash 56 and the subscriber public key from step 156 is encrypted with a randomly generated symmetric key. The randomly generated symmetric key is used to encrypt the transmission file 50. Upon the transmission file 50 being encrypted, the server public key is used to encrypt the randomly generated symmetric key. Method 150 then proceeds to step 164, where the encrypted transmission file 50 is transmitted to the management server 22, and more specifically transmitted to the server application 24. In an exemplary embodiment, the encrypted transmission file 50 and the encrypted symmetric key is transmitted through a secure channel such as SSL. Method 150 then proceeds to step 166, where the encrypted transmission file 50 that has been received at the server application 24 is decrypted. As the encrypted transmission file 50 was encrypted with the randomly generated symmetric key, the symmetric key must first be unencrypted. The key is decrypted with a private key that corresponds to the server application 24 public key described above. Upon the symmetric key being decrypted, the symmetric key is used to decrypt the encrypted transmission file 50. As the transmission file 50 has been decrypted, the server application 24, will therefore have accessible to it, the contents of the transmission file, including the subscriber identifier 52, the subscriber email 54, the subscriber password hash 56 and the subscriber public key from step 156. Method 150 then proceeds to step 168, which will look up and verify the correct subscriber record stored in the subscriber database 28. The server application 24, uses the subscriber identifier to look up the subscriber record and retrieve the stored subscriber email 54 and password hash created in step 112. The stored subscriber email 54 and stored subscriber password hash 56 are compared to the corresponding values from the transmission file. If at step 150, it is determined that the values that are being compared do not match, method 150 proceeds to step 169 where a message will be sent back to the activation process indicating that either an incorrect subscriber identifier, email address or password was entered If at step 168, it is determined that the values match, method 150 proceeds to step 170. At step 170, the subscriber public key is then recorded in the respective field of the subscriber database 28. In an exemplary embodiment, at step 170, a timestamp is recorded in the subscriber database 28. Method 150 then proceeds to step 172. At step 172, a notification message indicating that activation for the service has been completed is sent to the transmitting computing station 14. Method 150 then proceeds to step 174, where the subscriber private key that was generated in step 156 is encrypted with a randomly generated secret key (not shown) known only to the client application 16. The randomly generated secret key is then known only to the client application 16 and activation application 17. Method 150 then proceeds to step 176 where the encrypted subscriber private key is placed in a local keystore. In an exemplary embodiment, a local keystore is a container data file used to store one or many cryptographic keys. The file is saved in a location such that the client application has access to retrieve any key stored within the file.

Method 150 then proceeds to step 178 where a configuration file is created. In an exemplary embodiment, the configuration file is an XML file. The configuration file contains information used by the client application 16 during normal transmission and retrieval processing. The configuration information may include but is not limited to data storage and backup directories, proxy information, application version and subscriber email and associated encrypted private key. The configuration file is saved in a location such that the client application 16 has access to retrieve any data stored within the file. The structure of the configuration file allows for the storage of multiple subscriber email addresses and associated encrypted private keys. This enables subscribers to run the subscription method 100 and activation method 150 for multiple different email addresses that the subscriber may use.

Reference is now made to FIG. 6, where a sample email window 300 is shown. The sample email window 300 illustrates the components that are associated with an email message 12. The email window 300, as shown in FIG. 6, the email window 300 comprises a send button 301, a send encrypted button 302, a from field 305, a to field 310, a subject field 305, an attachments field 320, and a body field 325. The send button 301 is engaged when the user wishes to send the message that has been composed. The send encrypted button 302 is engaged when the user wishes to send the message as an encrypted message. The from field 315 is used to list the email address of the sender. The to field 310 is used to list the email address, or email addresses of the intended recipients. The subject field 315 lists the subject of the email. The attachments field 320A, provide an indicator if any files have been attached in this particular electronic mail message. The receipt request button 322 is used when the user wishes to receive a confirmation that the message has been received securely by the recipient. The body field 325 is used to write the body of the message.

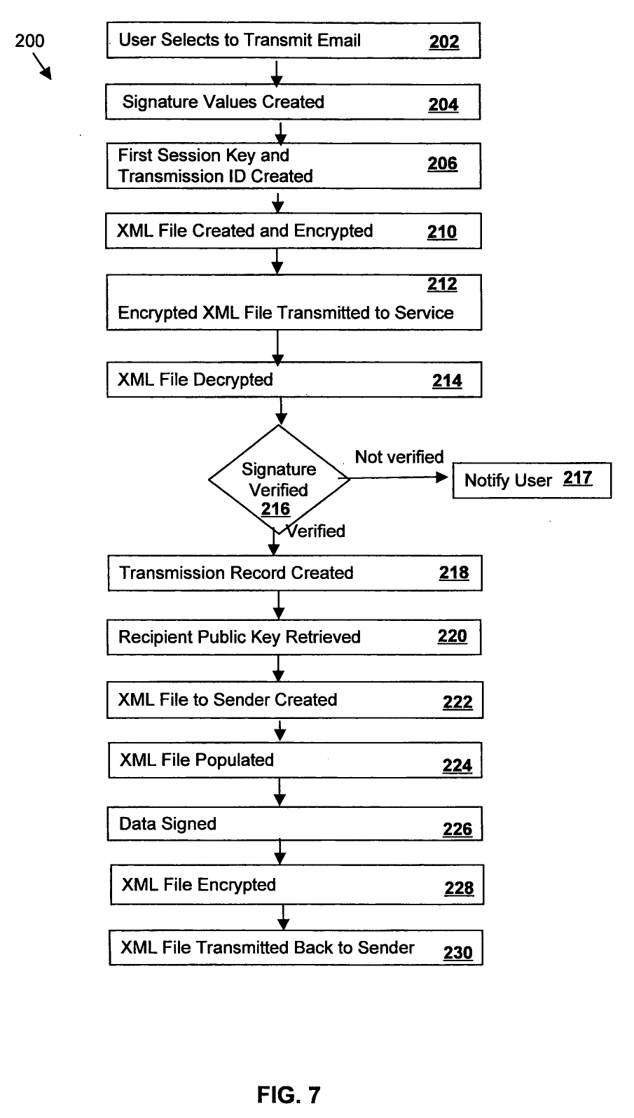

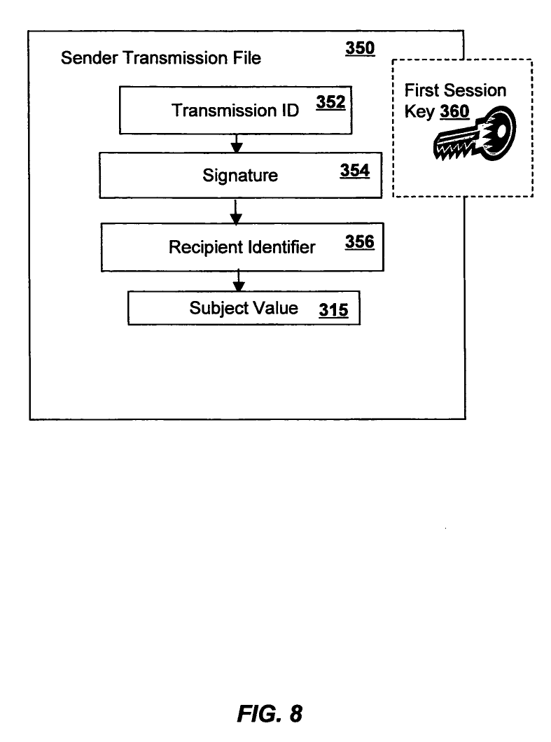

Reference is now made to FIG. 7, where the steps of an initiate transmission method 200 are shown in an exemplary embodiment. Reference is also made to FIG. 8, where a sample transmission file 350 and its components are illustrated. The initiate transmission method 200 will be described with reference to FIG. 8, where in an exemplary embodiment, a sender transmission file 350 is comprised of a transmission identification 352, digital signatures 354, one or more recipient identifiers 356, and the contents of the subject field 315. The transmission identification 352 is a unique identifier assigned to the transmission of the encrypted message. The digital signatures 354 are electronic signatures of components of the message 12 as will be described below. The recipient identifiers 356 are used to identify the recipients of the message. The initiate transmission method 200 is undertaken where a sender 30 who is a subscriber wishes to send an encrypted message 18 to one or more recipients. Method 200 is undertaken by a user who is using a computing station 14 upon which the client application 16 has been installed. Upon installation the client application 16 interfaces with the appropriate electronic mail application that is resident upon or accessible to the computing station 14. Method 200 begins at step 202, where the sender 30 selects to transmit an electronic message. In an exemplary embodiment, the sender has an option of transmitting the electronic message 12, such that it is encrypted or unencrypted. The user of the email application, in an exemplary embodiment, is presented with the option of transmitting an electronic message to the one or more intended recipients in an encrypted form, by specifying that the message is to be transmitted such that it is encrypted. Optionally, the sender 30 may also select to receive a read receipt confirmation by checking the receipt request 322 option. When the sender 30 has specified that the message is to be transmitted in an encrypted form, method 200 then proceeds to step 204, where various signature values associated with the electronic message are created. Reference is made again to FIG. 6, where the email window 300 is shown. At step 204, signature values are created of the various components of the email window 300. In an exemplary embodiment hash values are calculated for the contents of the from field 305, to: email addresses field 310, contents of the subject 315 line, body 325, the file names of all attached files 320 and the actual attached file data. A signature is then created from each hash value using the senders' private key. Method 200 then proceeds to step 206, where the client application creates a first session symmetric key and a transmission identification 352. In an exemplary embodiment, the symmetric key will have a length of 128 bits. The transmission identification is a globally unique identifier number that is used by the management server 22, to track each transmission through the system 10.

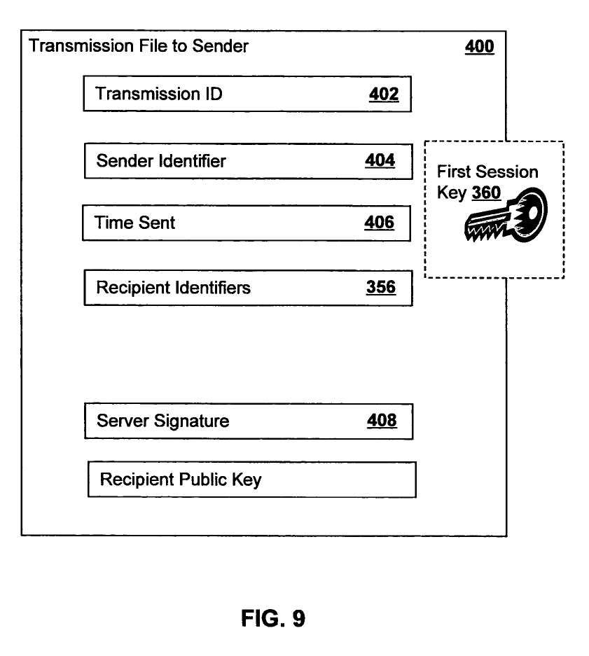

Method 200 then proceeds to step 210, where the sender transmission file 350 as shown in FIG. 8 is created. The sender transmission file 350, in an exemplary embodiment is an XML file, and may include, but is not limited to including the following components, the transmission identification 352, the digital signatures 354 as created in step 204 above, the recipient identifiers 356, receipt request flag 322 and the subject 315 content. The first session key 360 is then used to encrypt the transmission file 350. Also at step 210, the first session key, is encrypted with the server public key. Method 200 then proceeds to step 212. At step 212, the encrypted transmission file 350 along with the encrypted first session key 360 are transmitted to the management server 22, and more specifically to the server service 24. The encrypted transmission file 350 and the encrypted first session key are transmitted, in an exemplary embodiment through a secure communication channel, such as SSL. Method 200 then proceeds to step 214, where the encrypted transmission file 350 and the encrypted first session key are received at the server service 24. At step 214, the encrypted transmission file 350 and the encrypted first session key are both decrypted. The encrypted first session key, as it has been encrypted with the server public key is decrypted with the server application 24 private key. Upon decryption, the first session key is used to decrypt the encrypted transmission file 350. Upon the decryption of the transmission file, the components of the transmission file may be analyzed by the relevant applications associated with the management server 22. Method 200 then proceeds to step 216. At step 216, the signature that is contained in the transmission file 350 is verified to ensure that the transmitting party is a known trusted subscriber. If at step 216, the signature cannot be verified, method 200 is terminated and a notification message is sent back to the initiate transmission process on the sending computer workstation 14. If at step 216, it is determined that the signature is verified, method 200 proceeds to step 218. At step 218 a sent timestamp is created which will be included in each transmission record associated with this transmission event in the transmission database 30 as described below. A record is created for every signature value. A master transmission record for each recipient is then created and associated with each of the signature records. The master transmission record will also be populated with values contained in the sender transmission file such as transmission ID, request receipt Method 200 then proceeds to step 220, where for each recipient as identified by the recipient identifiers 356, the recipients respective public keys are retrieved from the subscriber database 28. If a recipient identifier is not located in the subscriber database 28, a non-subscriber flag will be set and no public key will be included for this recipient. Method 200 then proceeds to step 222, where a transmission file is created for data that is provided back to the sender. Reference is now made to FIG. 9, where a block diagram illustrating the components of a transmission file created at the management server 22 are shown. The transmission file for sender 400, in an exemplary embodiment is comprised of a transmission ID 402 a sender identifier 404, a time sent stamp 406, recipient identifiers 356, hash values 358, a server signature 408 and the public key for each recipient 410. The transmission file for sender 400 is transmitted from the server application 24, to the computing station 14 associated with the sender 30. In an exemplary embodiment the transmission file is an XML file. Method 200 then proceeds to step 224, where the transmission file 400 has the transmission ID 402, sender identifier 404, a time sent stamp 406, recipient identifiers 356, hash values 358, and the public key for each recipient 410 placed in the file. Method 200 then proceeds to step 226, where the session key is signed by the server application 24, and the resulting server signature 408 is placed in the transmission file. Method 200 proceeds to step 228, where the transmission file 400 is encrypted with the first session key, and transmitted to the computing station 14 associated with the sender at step 230. At the conclusion of method 200, the sender 30 will have received at their respective computing station 14, an encrypted transmission file 400 that will be decrypted and appropriately processed to allow for the intended message to be transmitted to the recipient 34.

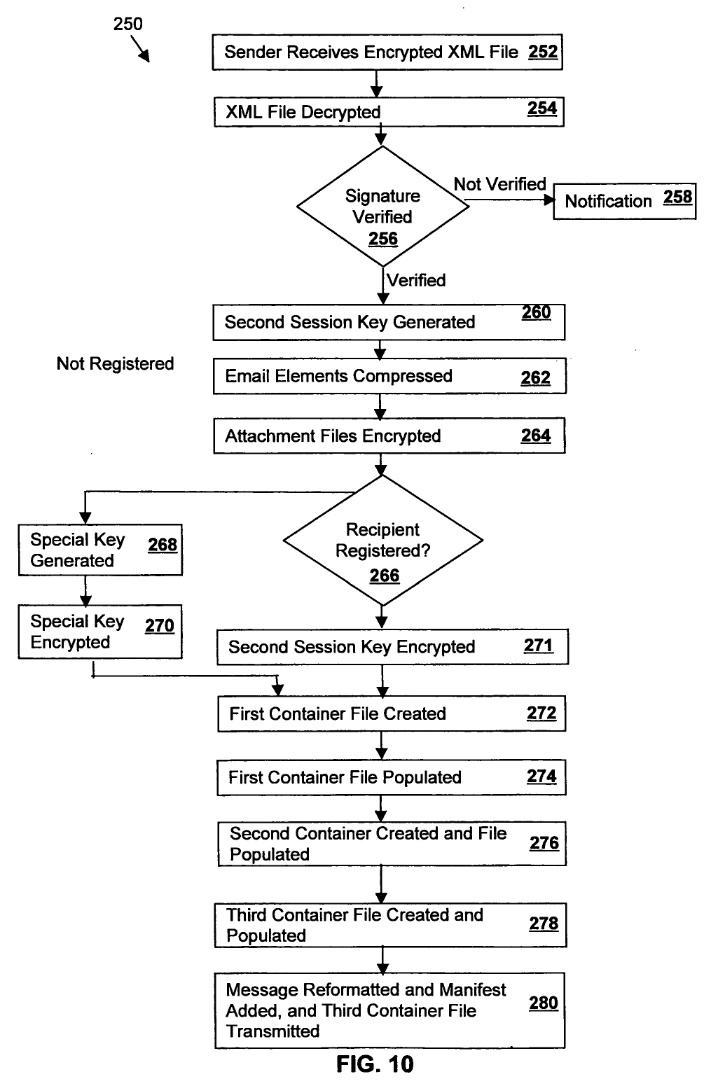

Reference is now made to FIG. 10, where the steps of the recipient transmission method 250 are shown in an exemplary embodiment. The recipient transmission method 250 in an exemplary embodiment, transmits the encrypted message 18 from the sender's computing station 14 to the recipients computing station 15, after the public keys for each recipient have been retrieved from the server application 24 using the initiate transmission method 200. In an exemplary embodiment, method 250 is implemented upon the sender's computing station 14, by the client application 17 that is resident upon the computing station 14. In an exemplary embodiment, method 250 begins at step 252, where the sender receives the encrypted transmission file 400. Method 250 then proceeds to step 254, where the transmission file is decrypted using the first session key 360 that has been transmitted along with the transmission file 400. Upon the transmission file 400 being decrypted, the server signature 408 is available to the client application. At step 256, the server signature 408 is verified as having originated from the server 22. If at step 256, the signature is verified, method 250 proceeds to step 260. If at step 256, the signature is not verified, the transmission file 400 will not have originated from the server application 24 and a notification at step 258 is displayed by the client application 17 indicating the error and further processing is stopped.

Method 250 then proceeds to step 260, where the client application 14 generates a second symmetric session key 365. In an exemplary embodiment, the symmetric key will have a length of 128 bits. Method 250 then proceeds to step 262, where various components of the electronic message as shown in FIG. 6, may be compressed. In an exemplary embodiment, the components of the message that are compressed include the attachment files 320, and the body field 325. Method 250 then proceeds to step 264, where if there are any attachments that the sender has specified as part of the electronic message 18, they are encrypted with the second session key 365. Method 250 then proceeds to step 266. At step 266, a check is performed to determine whether the recipients of the message, as indicated by the recipient identifiers 356, are registered subscribers of the system. The check at step 266, in an exemplary embodiment is performed by first determining whether any public keys belonging to any recipients have been transmitted from the server in transmission file 400 that was sent from the server 22. If public keys are present, the recipients have been identified as registered subscribers. If at step 266 it is determined that a recipient is not a registered subscriber of the system by presence of the non-subscriber flag for the associated recipient, method 250 proceeds to step 268. At step 268, a special encryption key (not shown) is created for each non-subscribed recipient. The special encryption key is created from the second session key 365, the sender identifier 404, and the recipient identifier 356 as described below. A fixed position data element is created such that bytes 0 to 48 are occupied by second session key 365, bytes 49 to 84 are occupied by the sender identifier 404 and bytes 85 to end of data element are occupied by the recipient email address. A new user symmetric session key is created. In an exemplary embodiment, the symmetric key will have a length of 128 bits. The populated fixed position data element is then encrypted with the new user session key. The new user session key is then encrypted with the server service public key. The special encryption key is now created by combining the server service public key, the encrypted new user session key and the encrypted fixed position data element into a data string. A special separator character is used to separate each of the server service public key, encrypted new user session key and the encrypted fixed position data element. In an exemplary embodiment, the separator character could be the ‘˜’. Method 250 then proceeds to step 272 If at step 266 it is determined that the recipients are registered subscribers, method 250 proceeds to step 271. At step 271, the second session key 365 is encrypted with each recipients public key 78.

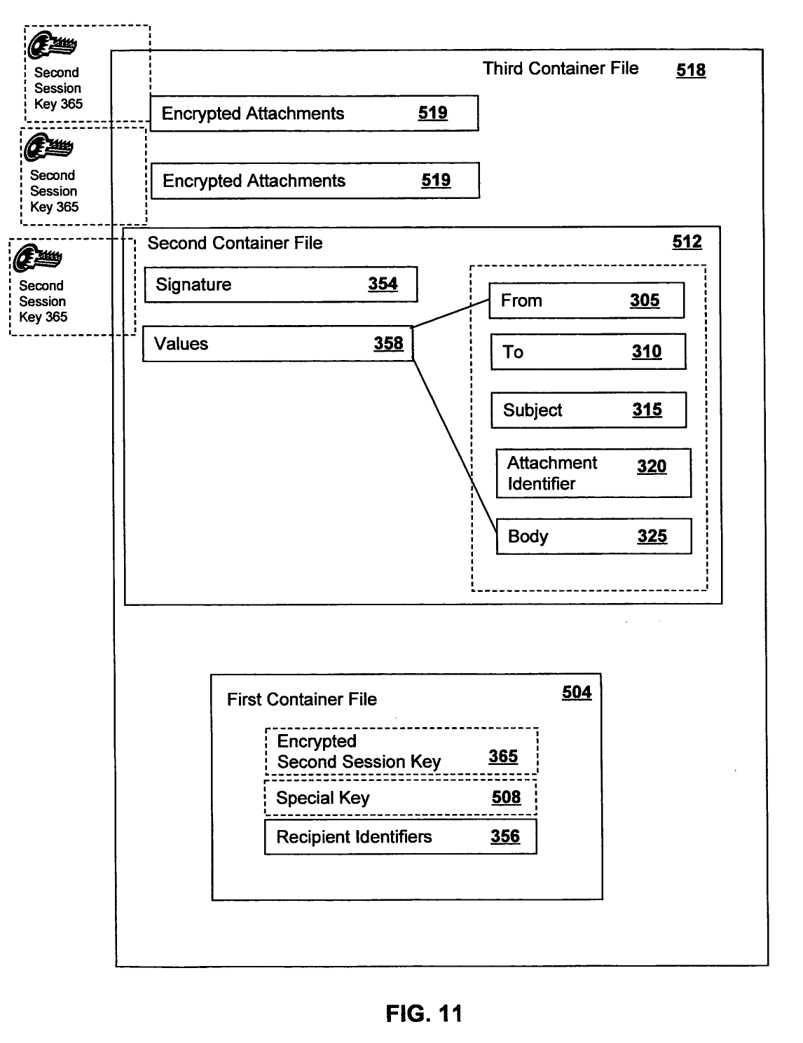

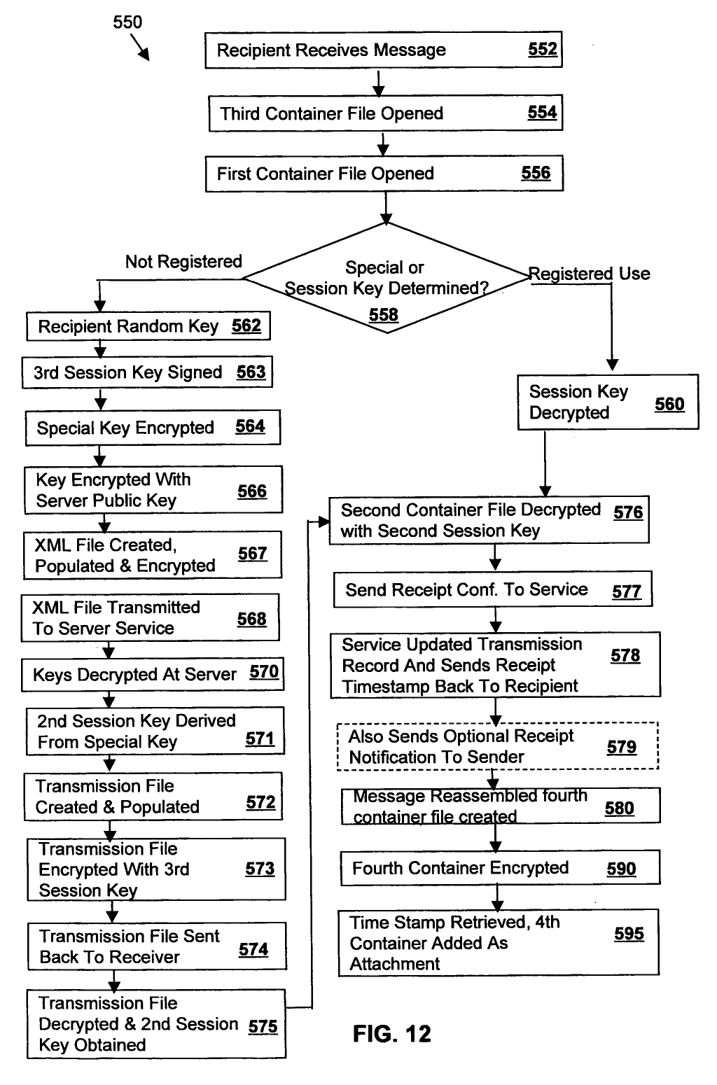

Method 250 then proceeds to step 272. At step 272, a first container file is created. The container file is an XML file in an exemplary embodiment. The container file contains a listing of all recipients and their associated encrypted second session keys. In the case of non-subscribed recipients the associated special encryption key is used and a new user flag is set. Reference is made to FIG. 11, where a block diagram illustrating the use of container files in an exemplary embodiment is shown. At step 272, a first container file 504 is created. Upon the creation of the first container file 504, method 250 proceeds to step 274. At step 274, the first container file is populated. In an exemplary embodiment, the container file is populated with the recipient email addresses and associated encrypted second session key 365, or the encrypted special key 508, depending on whether a special key was generated at step 268. When a special key is included, a new user element flag is set in the container file and associated with the appropriate recipient email address. Method 250 then proceeds to step 276. At step 276, a second container file 512 is created. The container file is an XML file in an exemplary embodiment, containing a listing of the sender and recipient identifiers as well as other information specific to the type of transmission and a signature for each element listed. Also at step 276, the second container file 512 is populated. In and exemplary embodiment the container file would contain the from email address 305, the to email addresses 310, Contents of the subject 315 line, the contents of the body 325 and the file names of all attached files 320. As shown in FIG. 11, The signature values 354, previously created in step 204 above are then added to the container file. The second container file 512 is then encrypted with the second session key 365. Method 250 then proceeds to step 278. At step 278, a third container file 518 is created. The container file may be a “Zip” file type which is commonly used to compress multiple data files into a single file. The third container file 518 is then populated with the first container file 504, and the second container file 512, and the encrypted attachments 519 that the sender wishes to transmit. The third container file is then named using the transmission ID created in step 206 as the first part of the file name. The file extension part of the file name is unique to the system 10 and when the client application 16 is installed on a Microsoft Windows operating system is registered so as to automatically launch the client application 16 during the receiving process described below. Method 250 then proceeds to step 280 where the third container file is transmitted to the recipients as an electronic message 18. In an exemplary embodiment the client application reformats the mail message as described below then sends it using the standard SMTP protocol. The original email address in the from field 305, the to field 310, and content of the subject lines 315 are not changed. The original attached files are detached from the mail message. The third container file is attached. The original message body is replaced with a manifest. The manifest is a plain text listing including but not limited to text indicating that this is a encrypted message sent using the system 10, timestamp for the transmission, sender identifier, receiver identifiers, transmission ID and original attached filenames. Upon the third container file 518 being transmitted, the recipients will receive electronic messages indicating that they have received encrypted messages 18. A further detailed explanation is provided with reference to FIG. 12, and recipient processing method 550. The recipient processing method 550 is engaged upon the recipients computing station 14 when an encrypted message is transmitted.

Method 550 begins at step 552, where the intended recipient receives the encrypted message. For purposes of discussion, method 550 is discussed as having the recipient of the encrypted message as a registered subscriber. If the recipient of the message is not a registered subscriber, the recipient may register with the service and install the applications that would allow for the appropriate processing to take place at the recipients computing station.

Method 550 proceeds to step 554, where the client application 16 resident upon, or accessible to the recipients computing station 14, processes the message that has been received. At step 554, the third container file 518 is opened. By opening the third container file 518, the first and second container files respectively may be accessed. Method 550 then proceeds to step 556, where the first container file 504 is accessed. When the first container file 504 is accessed, the container file contains either an encrypted second session key 365 or an encrypted special key 508 for the associated recipient. Method 550, then proceeds to step 558. At step 558, a check is performed to determine whether there is an encrypted second session key 365 or an encrypted special key 508 present by checking if the value for the new user element flag is set. If at step 558, it is determined that an encrypted second session key 365 has been included, method 550 proceeds to step 560, where the encrypted second session key 506 is decrypted using the recipients private key. If at step 558, it is determined that an encrypted special key 508 has been included in the first container file 504, and therefore used to encrypt the second container file 510, method 550 proceeds to step 562. At step 562, a third symmetric session key (not shown) is generated by the client application 16 installed on the receivers computing station 15. In an exemplary embodiment, the symmetric key will have a length of 128 bits. Method 550 then proceeds to step 563, where the third session key is signed by the receivers private key. Method 550 then proceeds to step 564, where the encrypted special key 508 is encrypted with the third session key. Method 550 then proceeds to step 566, where the third session key is encrypted using the server application 24 public key. Method 550 then proceeds to step 567 where the receiver transmission file is created and populated. The receiver transmission file, in an exemplary embodiment is an XML file, and may include, but is not limited to the following components, the transmission identification 352, the signed third session key as created in step 563 above, and the recipient email address. Once populated the receiver transmission file is encrypted with the third session key. Method 550 then proceeds to step 568, where the receiver transmission along with the encrypted third session key are transmitted to the server service 32, and more specifically to the management server 22. The encrypted receiver transmission file and the encrypted third session key are transmitted, in an exemplary embodiment through a secure communication channel, such as SSL. Method 550 then proceeds to step 570, where the server service at the management server 22 the keys transmitted at step 568 and verifies the signed third session key. If the signature does not match, an error notification is sent back to the receiver client application 16 and processing is stopped. The third session key is decrypted using the server public key, and the encrypted special key which has been encrypted with the third session key is decrypted with the third session key. Method 550 then proceeds to step 571 where the second session key is derived from the special key. More specifically the server service 32 reverses the process performed by step 268 above which was used to create the special encryption key. During this process the server service 32 also verifies that the recipient email address included in the recipient transmission file 567 matches the recipient email address stored in the special encryption key. If the email addresses do not match, an error notification is sent back to the receiver client application 16 and processing is stopped. This check ensures that only the intended recipient will receive the second session key for this encrypted message. Method 550 then proceeds to step 572, where a transmission file is created for data that is provided back to the receiver. In an exemplary embodiment the transmission file is an XML file containing the second session key. The transmission file may also include but not be limited to including a server service 24 signed copy of the second session key, the second session key and transmission ID. Method 550 then proceeds to step 573 where the transmission file is encrypted with the third session key. Method 550 then proceeds to step 574 where the encrypted transmission file is sent back to the receiver client application 16. Method 550 then proceeds to step 575, where the receiver client application extracts the second session key from the transmission file. The client application decrypts the transmission file with the third session key and opens the file. The signed session key is verified and if the signature does not match, an error notification is displayed to the user and processing is stopped. The second session key 365 is obtained. Method 550 then proceeds to step to step 576 where the second session key 365 is used to decrypt the second container file 512 and any attached files 320 with the second session key. The attached files 320 and the body 325 are then decompressed. Method 550 then proceeds to step 577 where the client updates the server service 24 with a receipt notice and retrieves a receipt timestamp. In an exemplary embodiment the transmission file is an XML file containing the transmission ID. The transmission file may also include but is not limited to the subject 315, sender identifier and signature. The client application 16 will generate a fourth symmetric session key, then sign this session key with server service 24 public key. The client application 16 will then encrypt the transmission file and send the encrypted transmission file and encrypted forth session key to the server service 24. Method 550 then proceed to step 578 where the server service 24 updates the original transmission record with a receipt timestamp and send the same receipt timestamp back to the receiver client application. When the server service 24 receives the encrypted fourth session key and encrypted transmission file from the receivers client application, it first decrypts the fourth session key, then decrypts the transmission file. The transmission file is then opened and the transmission ID is extracted and signature are extracted. The signature is verified. If the signature does not match, an error notification is sent back to the receiver client application 16 and processing is stopped. The server service 24 will use the transmission ID to update the associated record in the transmission database 30 with a receipt timestamp. The server service will also check the request receipt flag in the associated transmission record. If the request receipt flag 88 is set, the server service will create and send a receipt notification to the sender using the sender 89 value and recipient 86 value from the associated transmission record and the subject 315 from the transmission file. In an exemplary embodiment, the receipt notification will be in the form of an email message. The server service 24 will then create a transmission file containing the same receipt timestamp to send back to the receiver client application 16. In an exemplary embodiment the transmission file is an XML file containing the transmission ID, sent timestamp, receive timestamp and signed fourth session key. The server service 24 retrieves the sent timestamp from the associated transmission record. The server service 24 signs the fourth session key with the server service private key. The server service 24 then encrypts the transmission file with the fourth session key and sends the encrypted transmission file back to the receivers client application 16.

Method 550 then proceeds to step 579, where the receivers client application 16 reassembles the original message. In an exemplary embodiment the client application will extract the body 325 text from the decrypted second container and prefix it into body 325 of the email. The received timestamp will also be added to the manifest portion of the body that was added in step 280. Any attachments will be added to the email.

Method 550 then proceeds to step 585 where a fourth container file (not shown) is created. The fourth container file, in an exemplary embodiment is comprised of the unencrypted components of the email message and is used during the verification process described below. The fourth container file, in an exemplary embodiment, would contain but not be limited to the transmission ID, sender identifier contained in the from field 305, receiver identifiers contained in the to field 310, subject line 315, the message body text 325, and the attached file names 320.

Method 550, then proceeds to step 590, where the fourth container file is encrypted with the recipients public key

Method 550 then proceeds to step 595, where the encrypted fourth container is attached to the reassembled message. In an exemplary embodiment the fourth container is then named using the transmission ID as the first part of the file name. The file extension part of the file name is unique to the system 10.

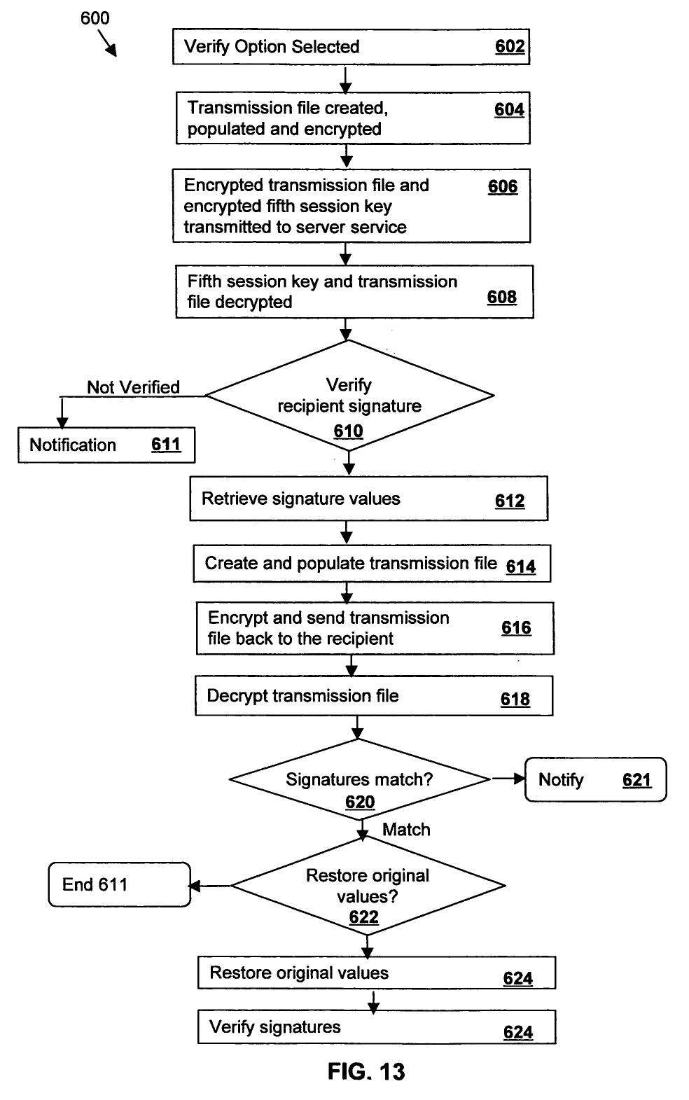

After method 550 has completed, the recipient may invoke an optional verification process 600. The verification process will compare the signatures taken of the various components of the electronic message 18 and stored in the transmission database 30 to the associated values of the decrypted components from method 550. Reference will now be made to FIG. 13. In an exemplary embodiment, the recipient may select the option to verify 601 the contents of the received electronic message 18. Method 600 starts at step 602 where the recipient user has selected the option to verify. Method 600 then proceeds to step 604 where transmission file is created. In an exemplary embodiment the transmission file is an XML file, and may include, but is not limited to including the following components, the transmission identification 352, the digital signature 354 and the recipient identifier 356. A fifth symmetric session key is created. The fifth session key is then used to encrypt the transmission file. Also at step 604, the fifth session key, is encrypted with the server public key. Method 600 then proceeds to step 608. At step 606, the encrypted transmission file along with the encrypted fifth session key are transmitted to the management server 22, and more specifically to the server service 24 The encrypted transmission file 350 and the encrypted first session key are transmitted, in an exemplary embodiment through a secure communication channel, such as SSL. Method 600 then proceeds to step 608, where the encrypted transmission file and the encrypted fifth session key are received at the server service 24. At step 608, the encrypted transmission file and the encrypted first session key are both decrypted. The encrypted fifth session key, as it has been encrypted with the server public key is decrypted with the server private key. Upon decryption, the fifth session key is used to decrypt the encrypted transmission file. Upon the decryption of the transmission file, the components of the transmission file may be analyzed by the relevant applications associated with the management server 22. Method 600 then proceeds to step 610. At step 610, the signature that is contained in the transmission file is verified to ensure that the transmitting party is a known trusted subscriber. If at step 625, the signature cannot be verified, method 600 is terminated and a notification message is sent back to the verify process on the recipient computer workstation 15 at step 611. At step 612, the server service will look up and retrieve the signature values for each signature record created from step 218 in the transmission database 30 that is associated with the transmission ID extracted from the transmission file. Method 600 then proceeds to step 614, where a transmission file is created. In an exemplary embodiment the transmission file is an XML file, and may include, but is not limited to including the following components, the transmission identification 352, the digital signature 354, the recipient identifier 356 and each signature value retrieved from the subscriber database 28. The server service 24 signs the fifth session key with the server service 24 public key. The server service then populates the transmission file with the transmission identification 352, the digital signature 354, the recipient identifier 356 and each signature value retrieved from the subscriber database 28. Method 600 then proceeds to step 616 where the server service encrypts the transmission file with the fifth session key and then sends the encrypted transmission file back to the recipient client application 16. Method 600 then proceeds to step 618 where the recipient client application 16 uses the fifth session key to decrypt the transmission file and extracts all of the signature values. Method 600 then proceeds to step 650. In an exemplary embodiment the signature values are verified against each of the associated from field 305, the to field 310, the contents of the subject 315, contents of the body 325, the file names of all attached files 320 and the actual attached file data with the exception of the fourth container file from the final assembled email message created at step 595 by method 550. If all of the signatures match, a notification is presented to the user by the client application 16 indicating that the electronic message have been successfully verified. If any one of combination of signatures do not match an error notification is presented to the user by the client application 16 indicating which element or combination of elements did not verify. Method 600 then proceeds to step 622 where the user is presented with an option to restore the original electronic message contents. If the user chooses not to restore the original values, method 600 ends. If the user selects the option to restore the original electronic message contents, method 600 proceeds to step 622. In an exemplary embodiment when the user selects the option to restore the original electronic message contents the client application 16 decrypts the fourth container file with the recipients 34 private key and will extract the sender identifier contained in the from field 305, receiver identifiers contained in the to field 310 subject line 315, the message body text 325, and the attached file names 320 and place them in the associated locations on the assembled email. Method 600 will then proceed to step 626 where the signature values obtained in step 618 are again verified against the each of the associated from fields 305, the to email addresses 310, the contents of the subject 315 line, contents of the body 325, the file names of all attached files 320 and the actual attached file data with the exception of the fourth container file from the final assembled email message created at step 595 by method 550. If any one or combination of the signature values do not verify, the client application will present an error notification to the recipient user indicating that the received electronic message has been either tampered with or corrupted since it was sent. The client application will indicate to the user which of the Subject: 315 line, contents of the Body: 325, the file names of all attached files 320 or the actual attached file data failed verification.

In alternative embodiments, the system 10 may be used to exchange messages, through web based email platforms, where the encryption and decryption and transmission of messages takes place as has been described above.

The present invention has been described with regard to exemplary embodiments. However, it will be obvious to persons skilled in the art that a number of variants and modifications can be made without departing from the scope of the invention as described herein

1. A method for the secure transmission of an electronic message from a sender to a recipient, the method comprising
a) receiving an encrypted sender transmission file transmitted from a sender computer station at a management server, wherein the sender transmission file comprises one or more signed hash values, a sender identifier and one or more recipient identifiers; wherein the one or more signature values are created from one or more message components associated with the electronic message composed at the sender computer station;
b) decrypting the encrypted sender transmission file;
c) comparing the one or more signed hash values accessible to the management server with one or more second hash values accessible to the recipient computer station;
d) retrieving for each of one or more recipient identifiers, one or more recipient public keys;
e) transmitting to the sender computer station a second transmission file, wherein the second transmission file contains the one or more recipient public keys, the sender identifiers, and the one or more recipient identifiers; wherein at the sender computer station a first container file is created, and is transmitted to the recipient computer station.

2. The method of claim 1, wherein the electronic message is an e-mail message.

3. The method of claim 1, wherein the one or more message components comprise a subject field, one or more attachments, and an e-mail body.

4. The method of claim 1, wherein the encrypted transmission file is encrypted with a first symmetric session key.

5. The method of claim 4, wherein the encrypted sender transmission file is transmitted to the management server along with the first symmetric session key.

6. The method of claim 1, wherein the first container file comprises all of the one or more email components.

7. The method of claim 6, wherein the first container file comprises a second container file and a third container file.

8. The method of claim 1, wherein the sender and the recipient subscribe to a key management service administered by the management server and become subscribers.

9. The method of claim 8, wherein each subscriber has a subscriber public key, and a subscriber private key pair.

10. The method of claim 9, wherein the subscriber public key and subscriber private key pair are generated upon configuration of the sender computer station.

11. The method of claim 8, wherein the subscriber public key is stored at the management server.

12. The method of claim 8, wherein the subscriber private key is stored in a keystore at the sender computer station.

13. The method of claim 1, wherein the first container file is transmitted as an as part of an e-mail message to the recipient computer station.

14. The method of claim 13, wherein the first container file is transmitted through the SMTP protocol.

15. The method of claim 1, wherein the first container file is transmitted as part of an FTP message.

16. The method of claim 13, wherein the recipient identifier is a recipient e-mail address.

17. A key management server system for processing encrypted electronic messages originating from a sender computer station destined for a recipient computer station; the system comprising:
a memory means comprising a transmission database and subscriber database, wherein the transmission datastore records transmission events, and the subscriber datastore records subscriber information
a processor means connected to the memory means, the processor operable to allow the key management server to:
i) receive an encrypted sender transmission file transmitted from the sender computer station wherein the sender transmission file comprises one or more first signed hash values, a sender identifier and one or more recipient identifiers; wherein the one or more hash values are created from one or more message components associated with an electronic message composed at the sender computer station;
ii) decrypt the encrypted sender transmission file;
iii) retrieve for each of one or more recipient identifiers, one or more recipient public keys stored in the subscriber datastore; and
iv) transmit to the sender computer station a second transmission file, wherein the second transmission file contains the one or more recipient public keys, the sender identifier, and the one or more recipient identifiers; wherein at the sender computer station a first container file is created, and is transmitted to the recipient computer station.

18. The system of claim 17, wherein the transmission datastore records a first timestamp when the sender encrypted transmission file is transmitted from the sender computer station.

19. The system of claim 17, wherein the transmission datastore records a second timestamp when the first container file is opened by the recipient computer station.

20. The system of claim 17, wherein a sender and a recipient subscribe to a key management service administered by the management server and become subscribers.

21. The system of claim 20, wherein each subscriber has a subscriber public key and a subscriber private key.

22. The system of claim 21, wherein the subscriber datastore securely stores each subscriber public key.

23. The system of claim 21, wherein the subscriber private key is stored at the subscriber computer station.
